(19) United States
(12) Patent Application Publication
(10) Pub. No.: US 2007/0236902 A1
(43) Pub. Date: Oct. 11, 2007

(54) Half-mesh backplane connection topology

(76) Inventors: Miriam E. Qunell, Naperville, IL (US); Robert F. Reed, El Dorado Hills, CA (US); Ernest Kaempfer, Huizen (NL)

Correspondence Address: Buckley, Maschoff & Talwalkar LLC;Attorneys for INTEL Corporation, Five Elm Street, New Canaan, CT, 06840, US

(21) Appl. No.: 11/393,242

(22) Filed: Mar. 30, 2006

(51) Int. Cl. H01R 12/16

(52) U.S. Cl. 361/788

(57) ABSTRACT

A backplane includes at least one central slot, a first plurality of slots on a first side of the central slot(s) and a second plurality of slots on an opposite side of the central slot(s). The backplane also includes a plurality of inter-slot connections, including a first subplurality between each of the slots of the first plurality and the central slot(s), a second subplurality between each of the slots of the second plurality and the central slot(s), and a third subplurality between each slot of the first plurality and each slot of the second plurality.

### BACKGROUND

The Peripheral Component Interconnect Industrial Computer Manufacturers Group 3.0 Advanced Telecommunications Computing Architecture (“PICMG 3.0 AdvancedTCA”) specification has been accepted as a standard for the backplane architecture for computing/telecommunications equipment. The PICMG 3.0 AdvancedTCA specification defines connector architecture for backplane slots, as well as certain connection topologies that may be provided by the backplane between slots. However, it may be desirable to provide more efficient and/or higher bandwidth capabilities than are provided by the topologies set forth in the PICMG 3.0 AdvancedTCA specification.

### BRIEF DESCRIPTION OF THE DRAWINGS

FIG. 1 is a schematic illustration of an item of computing/telecommunications equipment provided according to some embodiments.

FIG. 2 is a schematic illustration of a configuration of a backplane component of the equipment shown in FIG. 1.

FIG. 3 schematically illustrates a portion of the connection topology provided in the backplane of FIG. 2.

FIG. 4 schematically illustrates another portion of the connection topology provided in the backplane of FIG. 2.

FIG. 5 is a table that shows an example channel mapping to implement the connection topology shown in FIGS. 3 and 4.

### DETAILED DESCRIPTION

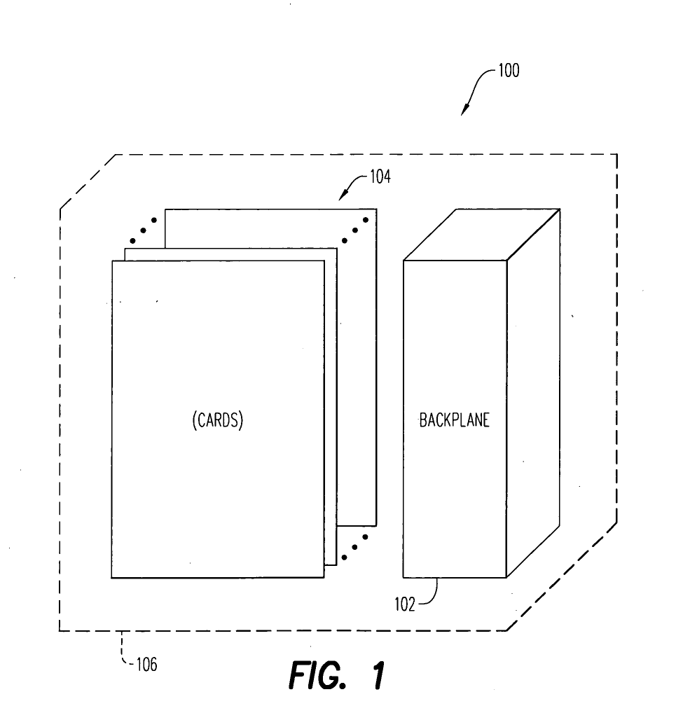

FIG. 1 is a schematic illustration of an item 100 of computing and/or telecommunications equipment provided according to some embodiments.

The item of equipment 100 includes a backplane 102 having slots (not separately shown) that may conform to the PICMG 3.0 AdvancedTCA specification. In addition, the backplane provides interconnections (by signal traces/vias that are not separately shown) among slots to implement a connection topology that is described below.

The item of equipment 100 includes a number of electronic device cards 104, each of which may be installed in a respective one of the backplane slots. The backplane 102 and the cards 104 may be held in a conventional chassis and/or housing, schematically represented at 106.

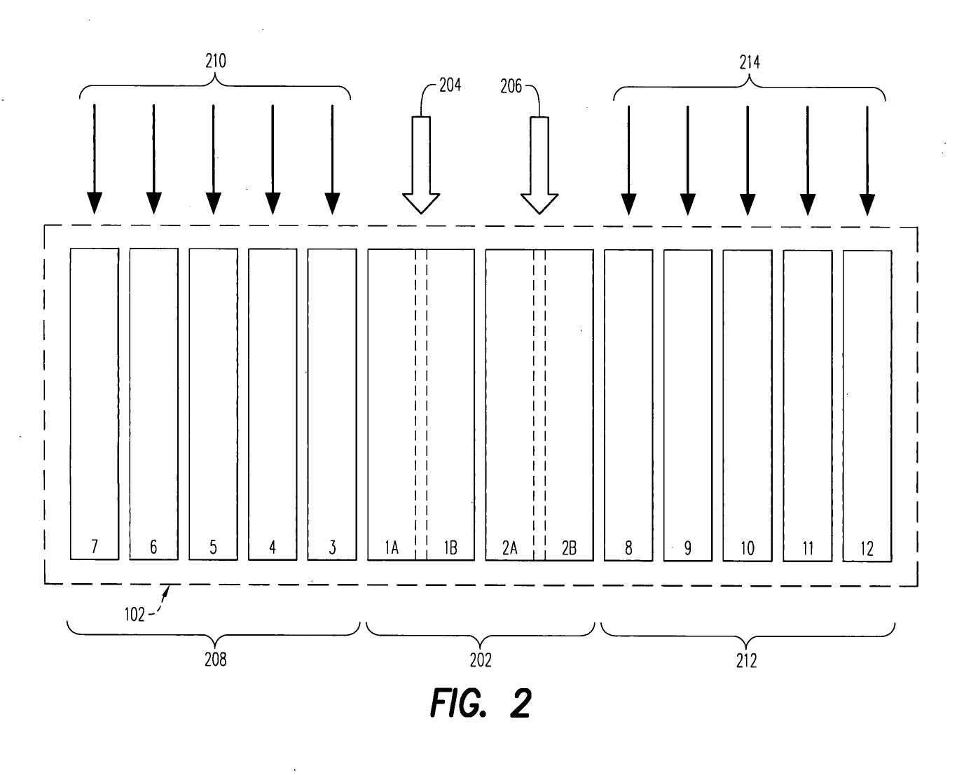

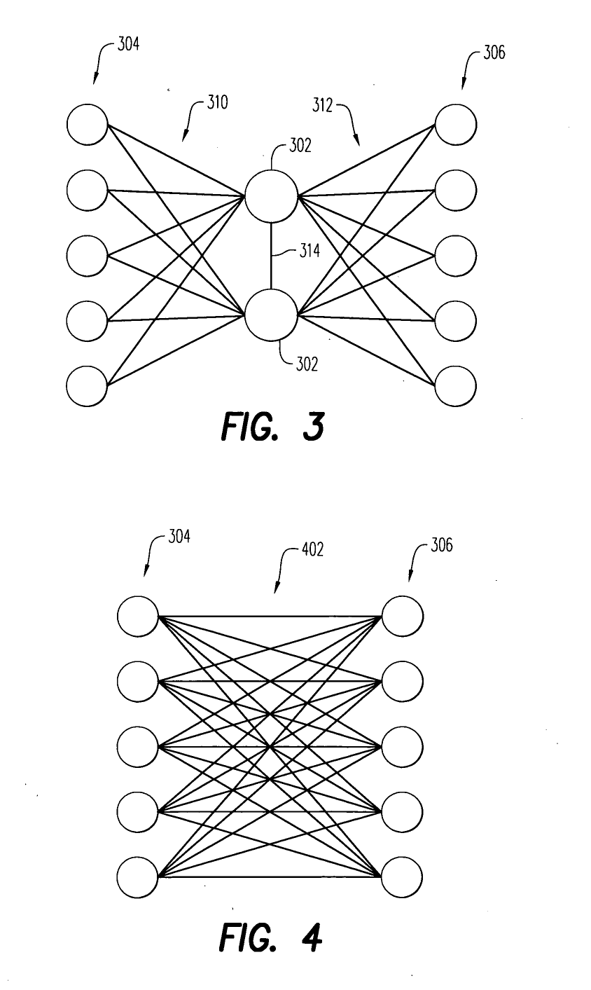

FIG. 2 is a schematic illustration of a configuration of the backplane 102. The backplane 102 includes four central slots indicated at 202, and configured as two pairs of slots given logical slot designations 1A, 1B (first pair) and 2A, 2B (second pair). Each pair of the central slots is configured to receive a respective double-width switching card to implement a dual star connection topology described below with reference to FIG. 3. The double-width switching cards are schematically represented by hollow arrows 204, 206.

The backplane 102 also includes five slots (indicated at 208) to the left side of the central slots 202 and given the logical numbering 3, 4, 5, 6, 7. Each of the slots 208 may be suitable for receiving a respective line card (each schematically represented by an arrow 210).

On the opposite side of the central slots 202 (i.e., on the right side of the central slots) are five more slots, which are indicated at 212 and are given the logical numbering 8, 9, 10, 11, 12. Each of the slots 212 may be suitable for receiving a respective line card (each schematically represented by an arrow 214). In some embodiments, service cards may be installed in the slots 212 in place of some or all of the line cards 214. Alternatively, in some embodiments, service cards may be installed in the slots 208 in place of some or all of the line cards 210. (As would be understood by those who are skilled in the art, a line card provides a physical input/output interface to a data transmission line, whereas a service card performs processing on data received via a line card.)

FIG. 3 schematically illustrates a portion of the connection topology provided in the backplane 102. In particular, FIG. 3 shows a conventional dual star inter-slot connection topology which is implemented as a portion of the connection topology provided by the backplane 102.

In FIG. 3, each of the larger circles 302 represents one of the two pairs of central slots 202 (FIG. 2). The five smaller circles (indicated at 304 in FIG. 3) at the left side of FIG. 3 each represent one of the left side slots 208 (FIG. 2). The five smaller circles (indicated at 306 in FIG. 3) at the right side of FIG. 3 each represent one of the right side slots 212 (FIG. 2). The lines indicated at 310 in FIG. 3 represent inter-slot conductive signal connections between each of the left side slots 304 and each pair 302 of the central slots. Each of the lines 310 may represent four 10 Gbs (gigabit per second) channels. The lines indicated at 312 represent inter-slot conductive signal connections between each of the right side slots 306 and each pair 302 of the central slots. Again each of the lines 312 may represent four 10 Gbs channels. Similarly, a connection is provided (represented by line 314) between the central slot pairs. It will be noted that considering this dual star topology alone, no connection is present between any of the slots indicated at 304, 306. Rather any connection between the slots 304, 306 must be made via switching at one of the central slots 302 (again considering just the dual star topology).

FIG. 4 schematically illustrates another portion of the connection topology provided in the backplane 102. As in FIG. 3, the five circles 304 each represent one of the left side slots 208 (FIG. 2) and the five circles 306 each represent one of the right side slots 212 (FIG. 2). The lines indicated at 402 represent inter-slot conductive signal connections between each of the left side slots 304 and each of the right side slots 306. Thus FIG. 4 shows a “half mesh” connection topology provided in the backplane 102 according to some embodiments in addition to the dual star topology shown in FIG. 3. Each of the lines 402 may represent four 10 Gbs channels. (The central slots do not enter into the half mesh connection topology.)

It will be noted that no slot of the left side slots 304 is connected to any other slot of the left side slots, and no slot of the right side slots 306 is connected to any other slot of the right side slots. For a “full mesh” topology to be implemented every one of the slots in the groups 304, 306 would have to be connected to every other one of the slots in those two groups. However, for the number of slots and the number of connectors provided in each slot, full mesh topology cannot be implemented to provide 40 Gbs of bandwidth between all pairs of slots.

The half mesh topology shown in FIG. 4 allows for “semi-random” direct datapath closure between slots that are on opposite sides of the array of slots. This may be useful for direct, full bandwidth, low latency ring closure and “one-plus-one” operation, without requiring complex fabric management or fabric bandwidth. It is also not necessary for the two connected slots to be adjacent as would be the case for update channels as referred to in the PICMG 3.0 AdvancedTCA specification.

The half mesh topology may also allow for direct, full bandwidth, low latency connections between line cards and service feature cards without using fabric bandwidth. For example, the cards in the five left side slots may all be line cards and the cards in the five right hand slots may all be service cards (or there may be fewer than five service cards), with each service card having a direct connection to up to five of the line cards on the left side.

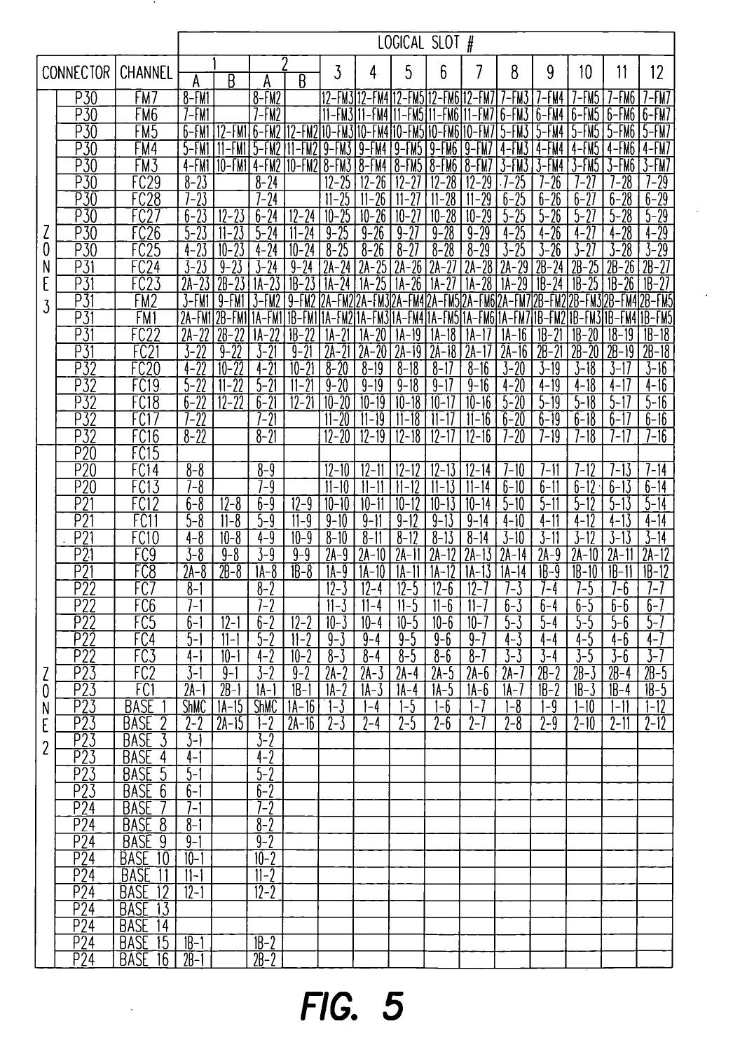

FIG. 5 is a table that shows an example channel mapping to implement the connection topology shown in FIGS. 3 and 4. It will be noted that “zone 3” of the connectors (indicated as “user definable” in the PICMG 3.0 AdvancedTCA specification) is employed to provide data connection channels (fabric channels or “FCs”) 16-29 as well as fabric management (“FM”) channels 1-7).

In the column entries in the “logical slot” columns (designated 1A, 1A, 2A, 2B through 12), the numeral before the hyphen (“-”) in each entry corresponds to the destination slot, and the numeral after the hyphen corresponds to the destination data connection channel in that slot. In addition to the data channel mapping and the fabric management channel mapping, FIG. 5 also shows the base interface mapping (at the bottom of the table).

(As used herein and in the appended claims “zone 2” and “zone 3” have the meanings as defined in the PICMG 3.0 AdvancedTCA specification, and correspond to regions of the connectors provided in the slots.)

The mapping shown in FIG. 5 is only an example of the numerous ways in which the combined dual star/half mesh topology may be realized. In the particular mapping shown in FIG. 5, most of the data connection channels of the central slots 1A, 1B, 2A, 2B are used for the dual star portion of the topology (the other data connection channels in the central slots are unused) and the data connection channels 1, 2, 8, 9, 21, 22, 23 and 24 of the left and right side slots are also used for the dual star portion of the topology. The other data connection channels of the left and right side slots are used for the half mesh portion of the topology, except for channel 15 which is not used.

It should be noted that the combined dual star/half mesh topology may also be implemented on backplanes having fewer than the 14 PICMG 3.0 AdvancedTCA slots illustrated in FIG. 2.

In some embodiments, the dual star topology may be replaced by a single star topology (e.g., slots 2A, 2B and the switching card installed therein may be eliminated). In other embodiments, the half mesh topology may be provided without either a dual star or a single star topology being present. For example, the topology of FIG. 4 may be present without the topology of FIG. 3 being present. I.e., the backplane may have only ten slots, interconnected as in FIG. 4, with the central slots 1A, 1B, 2A, 2B having been eliminated. It will be noted that the two groups of slots 3-7 and 8-12 are not interspersed with each other. As suggested by the previous paragraph, the half mesh topology may also be implemented with more or fewer than ten total slots. The two disjoint, half-mesh-connected connected groups of slots need not be equal to each other in terms of the number of slots in each group.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A backplane comprising:
at least one central slot;
a first plurality of slots on a first side of said at least one central slot;
a second plurality of slots on a second side of said at least one central slot, said second side opposite said first side; and
a plurality of inter-slot connections, said plurality of inter-slot connections including:
a first subplurality of connections connecting each slot of said first plurality of slots to said at least one central slot;
a second subplurality of connections connecting each slot of said second plurality of slots to said at least one central slot; and
a third subplurality of connections connecting each slot of said first plurality of slots to each slot of said second plurality of slots.

2. The backplane of claim 1, wherein no slot of said first plurality of slots is connected to any other slot of said first plurality of slots.

3. The backplane of claim 2, wherein no slot of said second plurality of slots is connected to any other slot of said second plurality of slots.

4. The backplane of claim 1, wherein no slot of said second plurality of slots is connected to any other slot of said second plurality of slots.

5. The backplane of claim 1, wherein the at least one central slot includes two pairs of central slots.

6. The backplane of claim 5, wherein:
the two pairs of central slots includes a first pair of central slots and a second pair of central slots; and
the plurality of inter-slot connections includes at least one connection connecting the first pair of central slots to the second pair of central slots.

7. The backplane of claim 5, wherein:
the first plurality of slots consists of five slots; and
the second plurality of slots consists of five slots.

8. The backplane of claim 7, wherein the third subplurality of connections provides four respective 10 Gbs channels between each slot of said first plurality of slots and each slot of said second plurality of slots.

9. The backplane of claim 8, wherein said first and second subpluralities of connections implement a dual star topology among said slots.

10. The backplane of claim 9, wherein each of said slots is provided in accordance with the Peripheral Component Interconnect Industrial Computer Manufacturers Group 3.0 Advanced Telecommunications Computing Architecture (PICMG 3.0 AdvancedTCA) specification.

11. The backplane of claim 10 wherein each of said slots includes connectors in zone 2 as defined in said PICMG 3.0 AdvancedTCA specification and in zone 3 as defined in said PICMG 3.0 AdvancedTCA specification.

12. An apparatus comprising:
two pairs of central slots;
a pair of double-width switching cards, each installed in a respective one of said two pairs of central slots;
a first plurality of slots consisting of five slots to the left of said central slots;
a second plurality of slots consisting of five slots to the right of said central slots;
backplane connections including:
a first plurality of backplane connections to implement a dual star connection topology among said slots; and
a second plurality of backplane connections to provide a respective direct channel between each slot of said first plurality of slots and each slot of said second plurality of slots; and
ten cards, each a line card or a service card, and each installed in a respective one of said slots of said first and second pluralities of slots.

13. The apparatus of claim 12, wherein no slot of said first plurality of slots is connected to any other slot of said first plurality of slots.

14. The apparatus of claim 13, wherein no slot of said second plurality of slots is connected to any other slot of said second plurality of slots.

15. The apparatus of claim 12, wherein no slot of said second plurality of slots is connected to any other slot of said second plurality of slots.

16. The apparatus of claim 12, wherein each of said slots is provided in accordance with the Peripheral Component Interconnect Industrial Computer Manufacturers Group 3.0 Advanced Telecommunications Computing Architecture (PICMG 3.0 AdvancedTCA) specification.

17. The apparatus of claim 16, wherein each of said slots includes connectors in zone 2 as defined in said PICMG 3.0 AdvancedTCA specification and in zone 3 as defined in said PICMG 3.0 AdvancedTCA specification.

18. A method comprising:
interconnecting ten cards, each a line card or a service card, via a dual star connection topology; and
also interconnecting subsets of said cards with a half-mesh connection topology.

19. The method of claim 18, wherein said half-mesh connection topology connects each one of a first five of said cards with each one of a second five of said cards.

20. The method of claim 19, wherein each of said cards is provided in accordance with the Peripheral Component Interconnect Industrial Computer Manufacturers Group 3.0 Advanced Telecommunications Computing Architecture (PICMG 3.0 AdvancedTCA) specification.

21. A backplane comprising:
a first plurality of slots;
a second plurality of slots; and
a plurality of inter-slot connections connecting each slot of said first plurality of slots to each slot of said second plurality of slots.

22. The backplane of claim 21, wherein:
no slot of said first plurality of slots is connected to any other slot of said first plurality of slots; and
no slot of said second plurality of slots is connected to any other slot of said second plurality of slots.

23. The backplane of claim 21, wherein said second plurality of slots is not interspersed with said first plurality of slots.
